(19) United States
(12) Patent Application Publication
(10) Pub. No.: US 2024/0328354 A1
(43) Pub. Date: Oct. 3, 2024

(54) SYSTEM FOR COOLING OIL IN AN AIRCRAFT TURBINE ENGINE

(71) Applicant: SAFRAN AERO BOOSTERS, Herstal (BE)

(72) Inventors: Xavier VANDENPLAS, Herstal (BE); Bruno SERVAIS, Herstal (BE)

(73) Assignee: SAFRAN AERO BOOSTERS, Herstal (BE)

(21) Appl. No.: 18/290,910

(22) PCT Filed: Jul. 5, 2022
(86) PCT No.: PCT/EP2022/068529

§ 371 Date: Jan. 22, 2024

(30) Foreign Application Priority Data
Jul. 22, 2021 (BE) BE2021/5572

(51) Int. Cl. F02C 7/14; F02C 7/06

(52) U.S. Cl. CPC F02C 7/14; F02C 7/18; F05D 2260/213

(57) ABSTRACT

A system for cooling oil in an aircraft turbine engine includes an intermediate support casing configured to be located between a low-pressure compressor and a high-pressure compressor of the aircraft turbine engine. The system further includes a heat exchanger for cooling the oil by heat exchange with air, wherein the heat exchanger is at least partially integrated into the intermediate support casing.

### TECHNICAL FIELD

The present invention relates to a system for cooling oil in an aircraft turbine engine.

### BACKGROUND

The increased performance of aircraft turbine engines is leading to an increase in thermal rejection towards the oil. A heat exchanger for cooling the oil is known, in particular, from the document BE2017/5735.

### SUMMARY OF THE INVENTION

The object of the invention is to improve the integration of a heat exchanger for cooling oil in an aircraft turbine engine.

To this end, the invention proposes a system for cooling oil in an aircraft turbine engine, and comprising an intermediate support casing intended to be located between a low-pressure compressor and a high-pressure compressor of the aircraft turbine engine, and a heat exchanger intended to cool the oil by heat exchange with air; the heat exchanger being at least partially integrated into the intermediate support casing.

The integration, at least partially, of the heat exchanger in the intermediate support casing results in a more compact and lighter turbine engine. It also reduces the production cost of the turbine engine.

According to advantageous embodiments of the invention, it may comprise one or more of the following characteristics, taken alone or in any possible technical combination:
the heat exchanger comprises a primary duct surface configured to be in a primary duct of the aircraft turbine engine;
the primary duct surface is configured to be between the most downstream vane of the low-pressure compressor and the most upstream vane of the high-pressure compressor;
the heat exchanger is configured to partially obstruct the primary duct;
the heat exchanger comprises a secondary duct surface configured to be in a secondary duct of the aircraft turbine engine;
the heat exchanger is configured to extend radially between the primary duct and a secondary duct, and comprises a secondary duct surface configured to be in a secondary duct of the aircraft turbine engine;
the heat exchanger is configured to partially obstruct the secondary duct;
the heat exchanger is annular and is configured to extend around an axis of the aircraft turbine engine;
the heat exchanger comprises fins configured to extend radially and parallel to the axis of the aircraft turbine engine;
the heat exchanger is a part attached to the intermediate support casing, or the heat exchanger and the intermediate support casing are made of the same part.

The invention also proposes an aircraft turbine engine comprising such a system, a low-pressure compressor and a high-pressure compressor, the intermediate support casing being located between the low-pressure compressor and the high-pressure compressor.

The invention also proposes an aircraft comprising such a turbine engine.

### BRIEF DESCRIPTION OF THE FIGURES

Further characteristics and advantages of the invention will become apparent from the following detailed description, for the understanding of which reference is made to the appended FIGURE:

FIG. 1 is a cross-sectional view, along the axis, of an aircraft turbine engine comprising an example of a system according to the invention.

### EMBODIMENTS OF THE INVENTION

This portion of the text describes in detail preferred embodiments of the invention. References to FIGURES are used but the invention is not limited by them. The drawings and/or FIGURES described below are schematic only and are not limiting.

In the context of this document, reference is made to the “axial”, “circumferential” and “radial” directions corresponding respectively to directions parallel to the drive axis, essentially circular around the drive axis, and perpendicular to the drive axis. Markings on the figures illustrate these directions (with an orientation), noted X, R and C respectively. The terms “inwardly” and “inwards” naturally correspond to an orientation towards the drive axis X in a radial direction, and the terms “outwardly” and “outwards” to the opposite orientation in this direction.

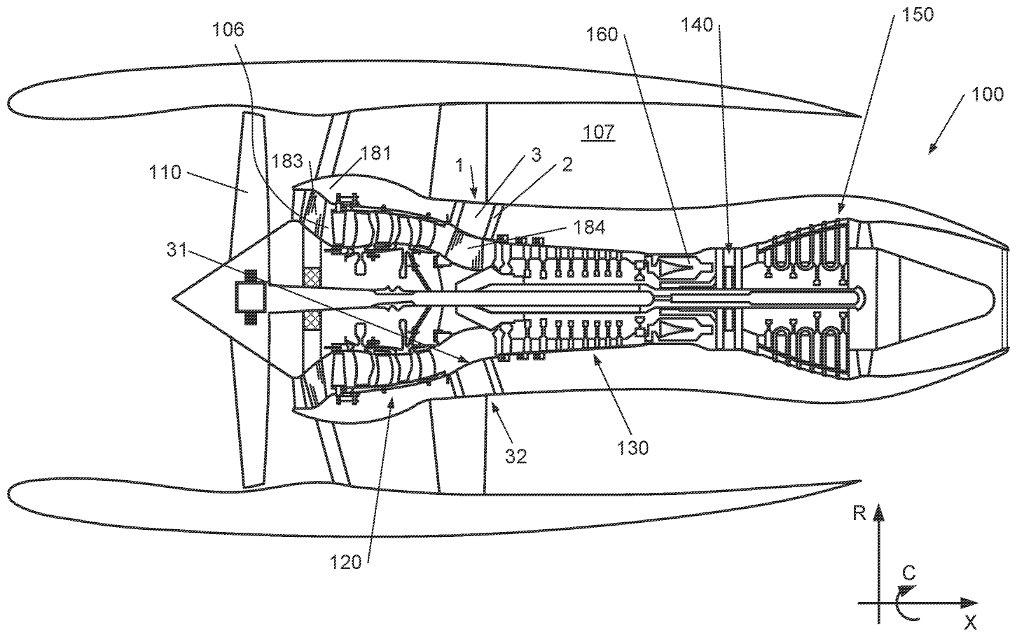

FIG. 1 illustrates an example of an aircraft turbine engine 100 comprising a system 1 for cooling oil according to one embodiment of the invention. The aircraft turbine engine 100 is an axial dual flow turbine engine comprising, in succession along the drive axis X, a fan 110, a low-pressure compressor 120, a high-pressure compressor 130, a combustion chamber 160, a high-pressure turbine 140 and a low-pressure turbine 150. The fan 110 generates a primary air stream in a primary duct 106 and a secondary air stream in a secondary duct 107.

The aircraft turbine engine 100 comprises an inlet support casing 181 located downstream of the fan 110. The inlet support casing 181 is provided with an annular handle delimiting the primary duct 106 and structural arms 183 which extend radially inwards through the primary duct 106.

The aircraft turbine engine 100 comprises an intermediate support casing 2 between the low-pressure 120 and high-pressure 130 compressors. The intermediate support casing 2 comprises an annular handle, preferably with a swan-neck profile, delimiting the primary duct 106 between the low-pressure 120 and high-pressure 130 compressors. It also has structural arms 184 extending radially across the primary duct 106.

The system 1 according to the invention comprises an intermediate support casing 2, for example as illustrated in FIG. 1, and a heat exchanger 3 at least partially integrated in the intermediate support casing 2. The heat exchanger 3 has at least one surface in the primary duct 106 and/or in the secondary duct 107 (FIG. 1). The heat exchanger 3 comprises a fluid inlet allowing oil to flow in and a fluid outlet allowing oil to flow out.

The heat exchanger 3 can be annular around the axis X of the turbine engine.

The heat exchanger 3 can be a part attached to the intermediate support casing 2 or be integral with the intermediate support casing 2.

The heat exchanger 3 may be axially at the same level as the structural arms 184.

In the example shown in FIG. 1, the heat exchanger 3 passes radially through the intermediate support casing 2 and has a primary duct surface 31, radially internal, in the primary duct 106, and a secondary duct surface 32, radially external, in the secondary duct 107.

The primary duct surface 31 is downstream of the most downstream vane of the low-pressure compressor 120, and upstream of the most upstream vane of the high-pressure compressor 130.

The heat exchanger 3 may comprise fins extending radially and parallel to the axis of the turbine engine.

The present invention has been described above in connection with specific embodiments, which are illustrative and should not be considered limiting. In a general manner, the present invention is not limited to the examples illustrated and/or described above. The use of the verbs “consist”, “include”, “comprise”, or any other variant, as well as their conjugations, can in no way exclude the presence of elements other than those mentioned. The use of the indefinite article “a”, “an”, or the definite article “the”, to introduce an element does not exclude the presence of a plurality of these elements. The reference numbers in the claims do not limit their scope.

1. A system for cooling oil in an aircraft turbine engine, the system comprising:
an intermediate support casing configured to be located between a low-pressure compressor and a high-pressure compressor of the aircraft turbine engine, and
a heat exchanger configured to cool the oil by heat exchange with air;
the heat exchanger being at least partially integrated into the intermediate support casing, wherein the heat exchanger comprises a primary duct surface configured to be in a primary duct of the aircraft turbine engine, the primary duct surface being configured to be between a most downstream vane of the low-pressure compressor, and a most upstream vane of the high-pressure compressor.

2. (canceled)

3. (canceled)

4. The system according to, wherein the heat exchanger is configured to partially obstruct the primary duct.

5. The system according to claim 1, wherein the heat exchanger comprises a secondary duct surface configured to be in a secondary duct of the aircraft turbine engine.

6. The system according to claim 1, wherein the heat exchanger is configured to extend radially between the primary duct and a secondary duct, and comprises a secondary duct surface configured to be in a secondary duct of the aircraft turbine engine.

7. The system according to claim 5, wherein the heat exchanger is configured to partially obstruct the secondary duct.

8. The system according to claim 1, wherein the heat exchanger is annular and is configured to extend around an axis of the aircraft turbine engine.

9. The system according to claim 1, wherein the heat exchanger comprises fins configured to extend radially and parallel to an axis of the aircraft turbine engine.

10. The system according to claim 1, wherein the heat exchanger is a part fixed to the intermediate support casing.

11. The system according to claim 1, wherein the heat exchanger and the intermediate support casing are made of the same part.

12. An aircraft turbine engine comprising the system according to claim 1, wherein the intermediate support casing is located between the low-pressure compressor and the high-pressure compressor.

13. The aircraft comprising the turbine engine according to claim 12.
